(19) United States
(12) Patent Application Publication
(10) Pub. No.: US 2005/0164151 A1
(43) Pub. Date: Jul. 28, 2005

(54) Educational talking calendar

(76) Inventor: Daniel Klein, Los Angeles, CA (US)

Correspondence Address: Joel D. Voelzke, Esq.;Fulwider Patton Lee & Utecht, LLC, Howard Hughes Center, 6060 Center Drive, 10th Floor, Los Angeles, CA, 90045, US

(21) Appl. No.: 10/765,687

(22) Filed: Jan. 27, 2004

(51) Int. Cl. G09B 19/12

(52) U.S. Cl. 434/304

(57) ABSTRACT

A talking calendar suitable for use as an educational toy for a child or a calendaring device for an adult includes a housing, an input microphone, an output speaker, a plurality of fixed function switches for accessing preprogrammed educational informational messages according to their subject matter, and a plurality of switches defining user-definable switches by which a user can record audio messages and play back those messages according to user-definable categories of information. Printed monthly calendar sheets for the different months of the year can be slid into the unit. The unit reads the month and year encoded on the calendar sheet. A switch matrix located underneath the monthly sheet senses when a user has pressed a day of the month and thereby selected a date for recording or playback of audio messages associated with the selected date.

### CROSS-REFERENCE TO RELATED APPLICATIONS

None.

### BACKGROUND OF THE INVENTION

1. Field of the Invention

This invention relates generally to the field of calendaring devices. More particularly, this invention relates to a talking calendar for use in the field of both children's educational toys as well as calendaring devices for adults.

2. Description of Related Art

A number of calendars and calendaring systems currently exist. Paper calendars were the traditional means by which people kept track of important dates and anniversaries, and created reminders to themselves. With the advent of the computer age a number of calendaring and reminder systems became available in the form of software applications for personal computers. Microsoft's Outlook® calendaring system provides one such calendar application. Calendaring systems are also available for personal digital assistant (PDA) type devices using the PALM® OS operating system. Calendaring systems have also been available via the Internet. U.S. Pat. No. 6,009,398 issued to Mueller et al. purports to disclose a speech based interface to electronic calendar systems for annotating calendar designated time periods as when scheduling, for example, appointments and events, and in which both the user and the calendar system may communicate with one another substantially verbally, or by keyboard and mouse or all of the those methods.

### INVENTION SUMMARY

The present invention provides a talking calendar which, in one embodiment, may be an educational toy in the form of a children's talking calendar. By touching a day within a visual representation of the current month, a child can hear prerecorded information pertaining to that date such as information about a historical event which occurred on that day in history or a holiday. In addition to having a speaker for playing back prerecorded information, the unit also has a microphone. By pressing the desired date on the calendar and the appropriate buttons, the user can record customized voice information associated with a particular date. The user can record recurring messages corresponding to recurring dates such as birthdays, or can make a voice record of onetime dates such as a family outing which occurred on that date, or other diary type information.

The battery-operated unit receives and holds printed monthly calendar sheets showing the days of the month for a particular month. The unit can come packaged with twelve or more plasticized printed calendar sheets, one sheet for each month of the current year, and possibly additional sheets for future years. The sheet for the current month is slid into a slot within the unit for receiving the sheet. The remaining currently unused eleven sheets are slid into a corresponding slot in the rear of the unit. The printed sheets may have usual dates noted thereon such as holidays and other important historical dates. The printed sheets include machine-readable codes indicating the month and year of each sheet. The unit reads the encoded information from the printed sheet and recognizes the month and year accordingly. The unit has a membrane switch matrix underneath the calendar sheet such that when a user presses one of the days of the month on the calendar sheet thereby selecting it, the unit recognizes which calendar date has been selected. By pressing appropriate buttons the user can hear various types of pre-recorded information that might be associated with that date. Alternatively, by pressing different dates the user can indicate that he wishes to record a voice message associated with that date for later playback, or that he wishes to hear information that he himself recorded for that date or a corresponding date from a prior year. The unit may also have a plug-in memory module which contains prerecorded information and/or nonvolatile writable memory for a particular year. The printed sheet can be a writable and possibly erasable sheet such that the user can make both visual notations on the sheet regarding a particular date, as well as record audio information pertaining to that date.

According to a first aspect of the invention therefore, the invention is of a talking calendar having a visual display such as a printed calendar sheet or an electronic display of days of year within a current year, a memory containing pre-recorded audio information pertaining to historical events from prior years, at least one sensor such as a mechanical button switch or a touch switch for detecting when a user selects a first day of year from the displayed days, a controller for selecting date-specific historical information from the memory according to the selected day of year and sending the date-specific historical information to an audio speaker for playing such that the user hears an educational message pertaining to a historical event which occurred on the selected day of year in a prior year, a microphone and associated controls allowing the user to make an audio recording and associate the recording with a particular day for later playback, and a place for holding unused sheets corresponding to the remaining months within the year.

Exemplary embodiments of the invention will be further described below with reference to the drawings, in which like numbers refer to like parts.

### BRIEF DESCRIPTION OF THE DRAWINGS

FIG. 1 is a top plan view of the talking calendar according to one embodiment of the present invention.

FIG. 2 is an exploded top perspective view of the unit showing the monthly calendar sheets removed from the unit.

FIG. 3 is an example of a printed monthly calendar sheet for use with one embodiment of the present invention.

FIG. 4 is a bottom plan view of the unit according to the embodiment.

FIG. 5 is a side elevation view of the unit with the monthly calendar sheets removed.

FIG. 6 is a view of one embodiment of the month/date encoding on the printed sheets and a corresponding optical code reader within the unit.

FIG. 7 is a simplified schematic diagram showing the major electrical components of the unit.

### DETAILED DESCRIPTION OF THE PREFERRED EMBODIMENTS

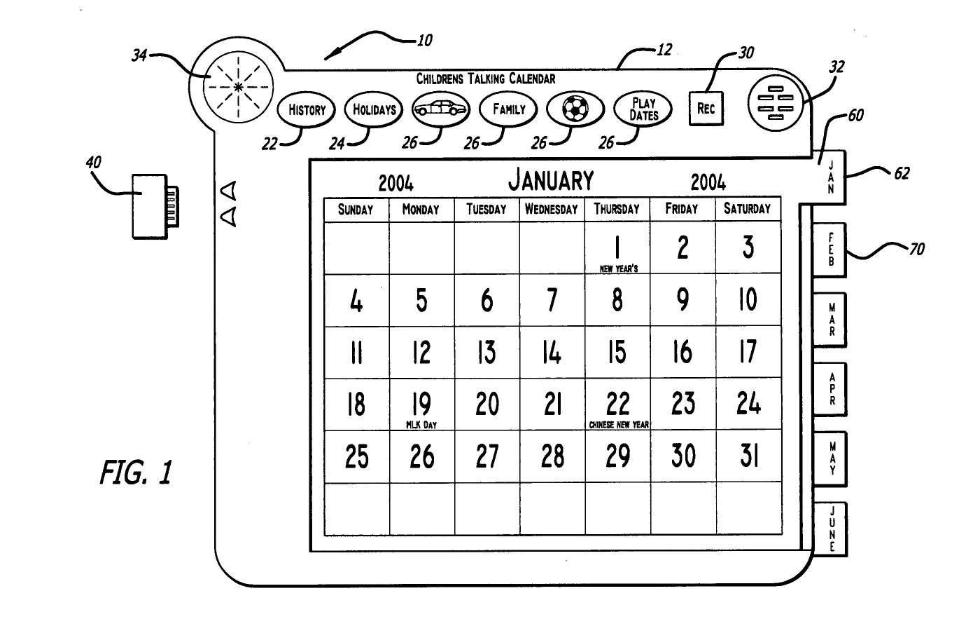

FIG. 1 is a top plan view of the talking calendar unit according to a first and exemplary embodiment of the present invention. The talking calendar unit 10 includes a housing or body 12, a display 60 which is a printed monthly calendar sheet in the embodiment shown for the month of January 2004 in the illustration, a number of additional monthly sheets 70, and a plug-in module 40. Affixed to or within housing 12 are an audio speaker 34, an audio microphone 32, a record button 30, fixed function switches or buttons 22 and 24, and a number of user defined function switches or buttons 26. Printed monthly sheet 60 provides a visual display of days of the month laid out in a familiar calendar grid format. Printed sheet 60 also includes printed indicia showing the month and the year. Other ways to display the days of the month are possible. Instead of a printed monthly calendar sheet, the display could be an electronic display such as a liquid crystal display (LCD), a plasma display, or other types of displays. In the embodiment shown, printed sheet 60 includes a tab 62 on the right hand side so that sheet 60 can be easily identified and remove from the unit 10.

Microphone 32 and speaker 34 are preferably encased within and protected by the shell of the unit 10 in order to protect them from physical damage. Buttons 22, 24, 26, and 30 can be physical buttons over mechanical switches such as membrane switches, or they can be more general buttons or switches such as touch switches. A large variety of suitable switch technologies are well known, including capacitative touch switches and solid state pressure sensitive switches. Printed sheet 60 is preferably a plasticized sheet such as a laminated paper or card stock sheet in order to give the sheet semi-rigidity and protection against physical damage including food and drink spills and stains. The plastic coating on sheet 60 could also be erasable as well as writable.

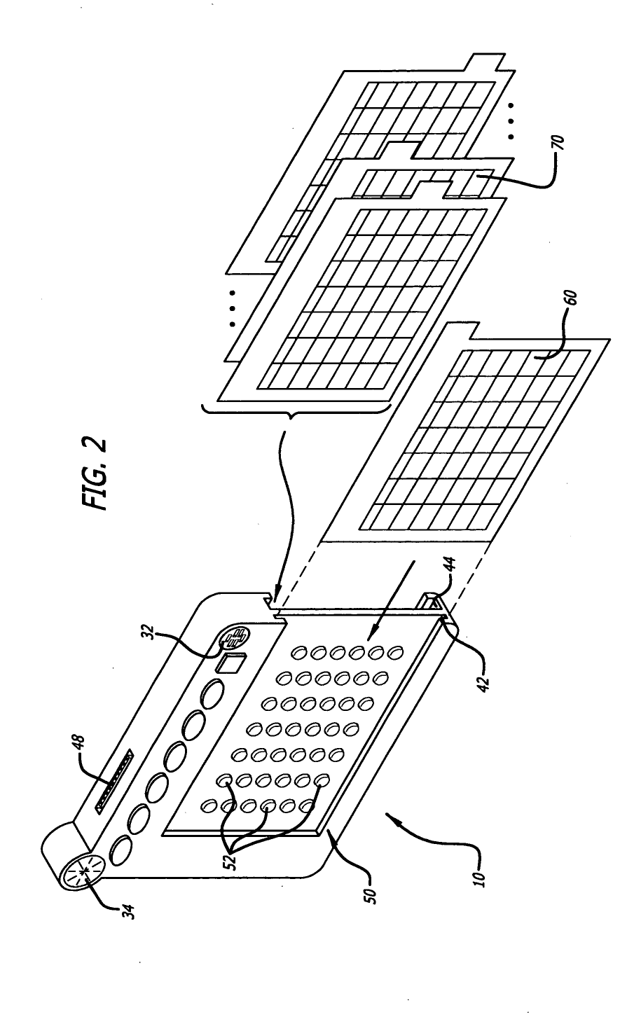

With reference to FIG. 2, the unit preferably includes means to hold selected monthly sheet 60 in place on or within the unit. In the embodiment shown, unit 10 includes a groove 42 forming a top slot into which selected sheet 60 is slid. The unit further includes a groove 44 forming a bottom slot into which the remainder of the calendar sheets, including sheets 70, are slid. Thus the unit includes both a place to firmly hold the sheet corresponding to the current calendar month, as well as a place to hold the sheets corresponding to the remaining 11 calendar months within the year.

Formed within or affixed to unit 10 is a switch matrix 50 containing a number of switches 52. Switch matrix 50 can, for example, be a rubberized membrane switch matrix, although the type of switches used is not critical. As one example, switch matrix 50 could be replaced by an optical switch matrix comprising row and column sensing light beams. In an alternative solid state display embodiment in which printed sheet 60 is replaced by a solid state display such as an LCD matrix, membrane switch matrix 50 could be replaced by any one of a number of known switch types for use with solid state displays, including light beam switches, capacitative touch switches, etc. Returning to the illustrative embodiment shown, when printed sheet 60 is slid into unit 10 it lines up with switch matrix 50 in such a way that each calendar day shown on the month lies above a corresponding switch 52. When a user presses a square corresponding to a particular day, switch 52 corresponding to that day is activated. In this way a user selects a particular day out of the possible days of the displayed month.

The unit 10 could also include an electronic interface 48 such as an RS-232 or other serial port for downloading information into unit 10 from a personal computer (PC) or uploading information to the personal computer. Information which could be downloaded could include information regarding what holidays fall on what days of the year and in which position on the calendar those days fall. For example, downloaded information could include the fact that in the year 2004 the Chinese New Year falls on January 21, and that January 21 in the year 2004 falls on the third Wednesday of the month, that is, that January 21 corresponds to row four, column four in switch matrix 50.

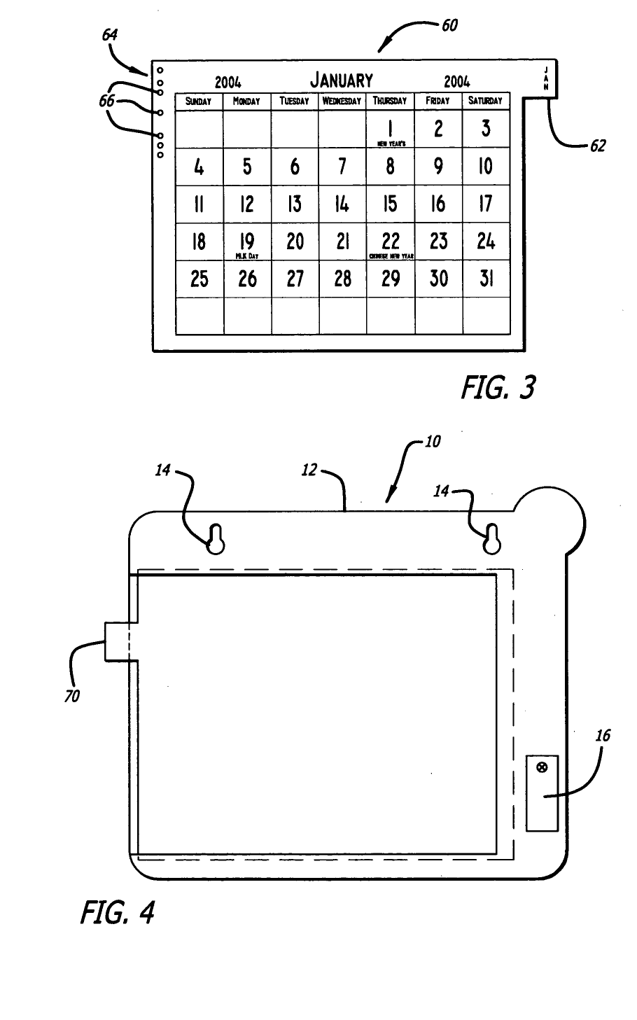

FIG. 3 is an example of a printed monthly calendar sheet 60 for use with one embodiment of the present invention. Printed calendar sheet 60 includes a tab 62 on the right hand side of the sheet indicating the month. Preferably the tabs on the different monthly sheets 70, etc. are staggered as illustrated in FIG. 1 so that the tabs of a number of different sheets are visible simultaneously. Monthly sheet 60 includes a listing of days of the month in a familiar calendar grid format as illustrated in FIG. 3. The monthly sheet comes preprinted with various holidays or other events printed within the squares corresponding to the respective appropriate dates. Sheet 60 can be arranged with either six rows of days across, or five rows across with Sunday and possibly Monday being split in the usual way in those few months per year in which such splitting is necessary in order to fit all of the days of the month within five rows. In the latter layout, the switches beneath Sunday and Monday would need to be capable of recognizing whether the top or bottom half of the day had been pressed. In the preferred embodiment, sheet 60 also includes a machine-readable code 64 in which the date and preferably the year as well are encoded. In the example shown, machine-readable code 64 comprises a set of holes 66 which together form a code which can be read by an optical reader. Alternatively, many other types of machine-readable code are possible. Machine-readable code 64 could be a bar code, an optical code comprised of darkened circles or bars, a series of physical tabs extending outwardly from the nominal edge of the sheet, metallic coated areas or fingers to complete electrical circuits, or any other suitable machine readable encoding such as is well known within the relevant art. In the case of physical tabs, the unit could read the encoding either by sensing the presence or absence of the tabs optically or by sensing them mechanically or electrically.

Various information and data can be made available to unit 10 using either plug-in memory module 40, computer interface port 48, or a combination of the two. In a first embodiment plug-in module 40 contains both read-only memory (ROM) and a non-volatile writable memory such as EEPROM flash memory, or simply flash memory. Memory module 40 could be a standard smart disk, compact flash memory, or other memory encased in a uniquely designed case. The ROM includes all of the pre-recorded educational information concerning storage dates and holidays, as well as information regarding what days of what years will correspond to which column and row numbers within switch matrix 50. Each module 40 could correspond to one year such that the user changes modules once per year, or could contain information regarding a number of different years. The unit could come with a number of separate adhesive year labels from which the user could choose in order to label a set of modules 40 which would come with the unit as corresponding to particular selected years. The information recorded by the user could be stored within nonvolatile memory within module 40. Alternatively, the information recorded by the user could be stored in other nonvolatile memory within unit 10. Various types of suitable non-volatile memory are well-known including EPROM, EEPROM, flash memory, ferroelectric RAM (FRAM), and battery-backup RAM.

FIG. 4 is a bottom plan view of the unit according to the illustrative embodiment with only one stored sheet 70 in the unit. The body 12 of unit 10 includes two hanger holes 14 or other hanging mechanism so that the unit can be conveniently hung on a wall. The unit can be either mounted on a wall, or hand held, or used on a table top. The unit also includes a battery compartment cover 16 which holds batteries for powering the unit.

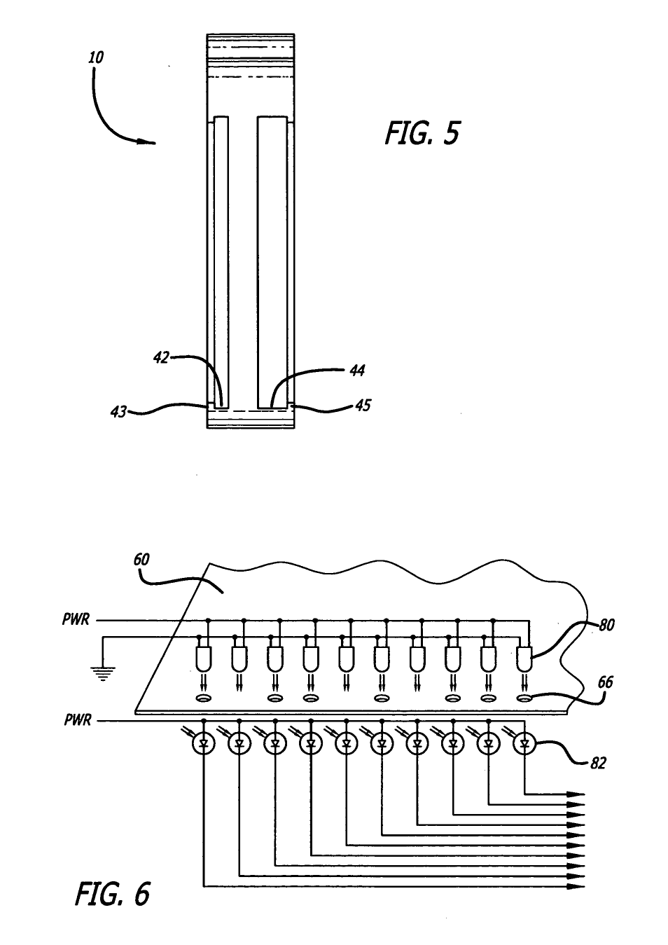

FIG. 5 is a side elevation view of the unit with the monthly calendar sheets removed. The top side of the unit includes groove 42 underneath lip 43 forming the slot for holding the current calendar sheet The bottom side of the unit includes groove 44 and lip 45 forming the slot for holding the currently unused calendar sheets.

FIG. 6 is a view of one embodiment of the month/date encoding on the printed sheets and a corresponding optical code reader within the unit. One or more light emitting lamps 80 such as LEDs mounted into body 12 shine light onto holes 66 within calendar sheet 60. A plurality of light sensors 82 also mounted into body 12 detect the presence or absence of holes 66, thus reading the month and year encoded onto sheet 60. The implementation details of this and other machine-readable codes are well-known, and are within the ordinary skill of persons in the relevant art.

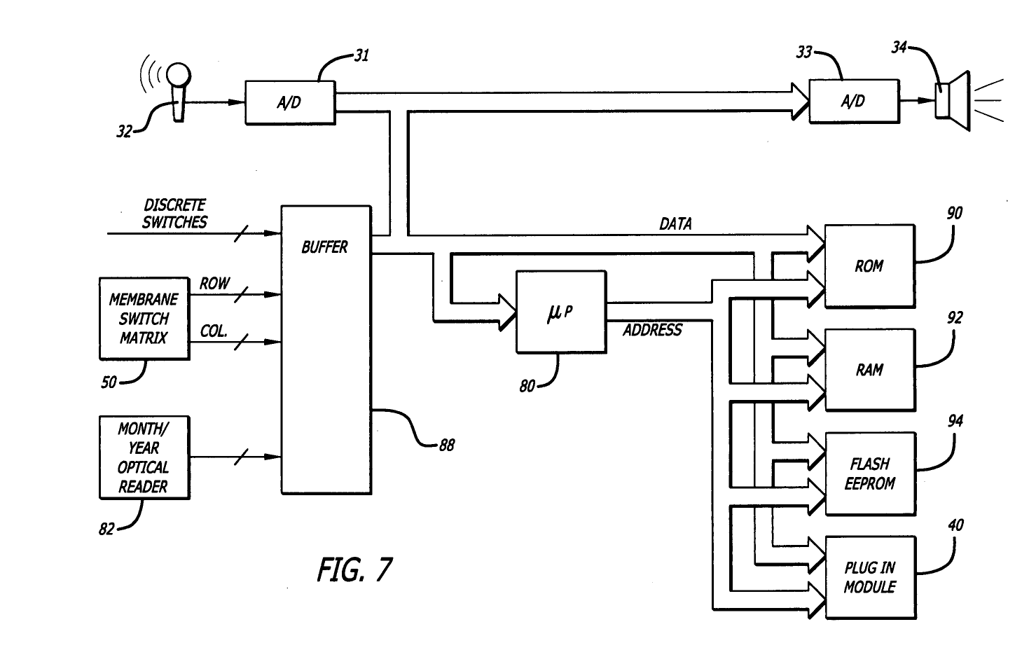

FIG. 7 is a simplified electrical schematic diagram showing the major electrical components of the unit according to one possible construction of the illustrated embodiment. Microprocessor 80 receives inputs from the discrete switches 22, 24, 26, and 30, and from membrane switch matrix 50 and from the month/year optical reader 82, via a buffer 88. Microprocessor 80 also receives inputs from microphone 32 via analog-to-digital converter (ADC) 31. Microprocessor 80 also retrieves digital data from ROM 90, RAM 92, Flash memory 94, and from plug-in module 40. Microprocessor 80 synthesizes speech by sending data to digital-to-analog converter (DAC) 33 which converts the digital data stream to an analog output signal for reproduction at speaker 34. In the simplified electrical schematic diagram various details are omitted for clarity. Those details include address decoding, an analog amplifier, the electrical components of computer interface 48, and others. Those details are routine details and within the skill of the ordinary practitioner within the relevant art. Likewise, the software for implementing the functions disclosed herein are also within the skill of the ordinary software engineer to write and implement. The details of the electrical design are not important, and many other possible architectural implementations of the functions disclosed herein are possible.

The unit could come with a sheet of adhesive labels or stickers for labeling the various user programmable buttons. In a preferred embodiment, the adhesive labels would be fun, brightly colored vinyl adhesive stickers with pictograms and/or words, and in colors that contrast with the unit body 12, and that a child can remove from the label sheet and adhere to the various buttons in order to define the types of information that the child will record using those buttons. Sample categories of user definable buttons might include family events, school events, homework, sports league events and other after school events, pets, play dates, and friends. Blank stickers can also be provided so that a user can write an appropriate label on the sticker and use the sticker to create a user-definable category. Using the various controls available, the user can identify an event as a onetime event such as a school performance, or a recurring event such as a birthday within the family including a pet's birthday. Recurring events are stored for retrieval in later years upon each anniversary of an event.

Additional indicators, buttons, and controls are possible. In a preferred embodiment the device includes a power on/off switch as well as an automatic power-off or battery saver feature, a low battery indicator lamp, a “recording” indicator lamp, and a volume control. The unit could also include additional control buttons for configuring the device, or user could press a combination of buttons to put the device into the program mode. For example, a user could press the record button 30 and the history button 22 simultaneously for two seconds, and then press the record button 30 and holidays button 24 simultaneously for two seconds in order to place the unit in program mode. In the children's talking calendar version, the program mode would be accessible for adults to program the device for use by their children. Once the device is in program mode, the user could select the function keys 22 through 30 and/or the numerical days on the calendar, in order to configure the device. The unit could be preprogrammed with different messages appropriate for children of different ages, ethnicities, religions, or interests, with the parent selecting from among the preprogrammed educational messages the set of messages appropriate for the child. For example, a parent may wish to configure the device for an English-speaking child of ages five through seven, with information regarding all secular holidays and holidays of all of the major religions to be available, and with the history button accessing information regarding American history.

For calendar days for which no particular event is associated in history, and which are therefore otherwise unused days, the calendar could include a more general, non date-specific educational message, or entertainment messages such as a humorous message from a cartoon or movie character.

The unit could come with application software for a PC in the form of a floppy disc or CD ROM disc. The software could perform a variety of tasks including providing a convenient interface for configuring the device through the interface port 48, providing supplemental educational information, or retrieving information from the device vendor's website for programming into the device. For example, if the child is particularly interested in the subject of trains, the parent could select from the vendor's website for downloading historical information regarding trains. The information would be downloaded first into the parent's PC, which would then program the device via the interface port 48 with the downloaded information and files. The child could then access that historical information by selecting the appropriate day on the calendar. The application software could also print monthly calendar sheets complete with blackened circles or a bar code for reading by the unit, along with holidays or other category-selected dates printed in the appropriate day square. In this way the unit could be highly customized depending on a child's age, gender, nationality, geographical region, ethnicity, religious affiliation, or other interests or affiliations. The same calendar can be used as the child grows older and/or his interests change, without any need to change or purchase new hardware. Additionally, permanent records of the child's own voice recordings can be uploaded to a personal computer for playback possibly many years later. The range of information available through the software could also be available through plug-in module 40 if the module comes pre-recorded, subject to the storage limitations of module 40.

The unit includes one or more buttons that offer preset, digitally recorded information in various subjects offered. In the embodiment shown, those subjects are History and Holidays, but need not be limited to those categories. Possible subjects for the preset buttons include: (a) historical events in American and international history, which may include significant events such as pioneer exploration, the Civil War, the world wars, and national cultural events such as the civil rights movement; (b) religious observances; (c) national and cultural holidays; (d) children's historical events. The educational message may include both historical accounts, as well as background information about the event or holiday, or follow-up information.

In operation, when the user presses the selected preprogrammed event button and the selected day square on the monthly insert sheet, the unit will playback the preprogrammed event message for that particular day in the category selected. If there is no message recorded for that day in that particular category, no message will be played back. Alternatively, a more general message could be played back.

To store a user recorded event, the user presses the record button 30, then one of the user programmable buttons 26 and then press the day for which the user recording will be associated. When the record button is first pressed, a red light emitting diode (LED) will blink, indicating standby for the recording function. When the day square is pressed, the red LED light will glow steadily indicating that recording is proceeding. The record function may be voice actuated so that when the user is done speaking the recording will stop automatically and the recording LED light will shut off.

When the unit is turned on either by operation of a manual power on/off switch or by the unit sensing activity at the buttons, the user may then press any of the pre-programmed buttons, followed by pressing one of the individual day squares on the monthly insert. If there are any events pre-programmed for that day for the particular category activated, that recording corresponding to the day selected will be played via a preprogrammed digital audio file through the unit's audio speaker 34. The digital files audio may be mp3, mp4, or other audio format. The user may adjust the volume of the playback via the volume control.

After listening to any preprogrammed events for that particular day, the user may choose to listen to any of the user programmed events corresponding to any particular category that the user has designated for the user programmable buttons, either predesignated or labeled by the user from the sheet of labels that may be supplied with the unit. The user presses the labeled button and then presses the square on the monthly insert for the day desired. Any events recorded for that day will then be played. At any time during a recording playback, if another category button is pressed the currently playing message will stop. Once the user programmed button is pressed, followed by pressing the day square on the monthly insert, the user may press any other day on the monthly insert and any events recorded in the user programmed category for those days will be displayed. If there is a significant delay between day squares pressed, the unit will revert to standby mode.

To record a user programmable event, the user will press in succession the record button followed by a user programmable button followed by pressing a day square on the monthly insert. If there is a significant delay between pressing any of the buttons or day squares, the unit will revert to standby mode. When the user presses the record button, a red LED light will blink, indicating standby for the recording function. Then the user presses one of the user programmable buttons followed by a day square on the monthly insert. When the day square is pressed, the blinking red LED light will stop blinking and glow steadily, indicating that recording is proceeding. The record function is voice actuated so that when the user is done speaking, the recording will stop and the recording LED light will shut off. The event is now stored for future playback in the category chosen anytime the current monthly insert is inserted.

When the current year ends, the user may purchase the next year's monthly insert sheets and memory module 40 and continue to use the unit, in the embodiment in which each plug-in module 40 corresponds to a particular year. If the user wishes to go back to listen to any events in any previous year, he may do so simply by reinserting the module and monthly inserts for that year.

The invention is not limited in its application to a children's talking calendar. Rather, the invention can be used in other applications for adults, with appropriate changes to the unit's appearance and categories of information. For example, a preprogrammed event might be an event unique to a university such as the university sports team's schedules, or the first day of registration for classes the following semester, the beginning of finals, or other events in student life. When the day is selected which corresponds to the first day of registration for classes, for example, the calendar would give information to the student regarding the process for registering for classes for the following semester. It is anticipated that in the adult versions of the unit, the number of category buttons would be smaller in size but larger in number than in the children's calendar version. User programmable categories could include, for example, the various classes that the student is taking.

In a workplace version of the unit, daily employee buttons may be used to record and play messages left either by employee for anyone else or for the employee. Industrial theme messages with corresponding OSHA or other workplace information would be preprogrammed for the otherwise unused day squares on each month. The preprogrammed message could be either an educational message, a humorous message such as a short satirical message regarding professional life, or a message that is both educational and humorous. Preprogrammed events could include national holidays, workplace holidays, and industry events unique to that industry such as national conventions. User programmable categories and corresponding labels may include a variety of subjects from which the user can choose including employee names, days off or times in or out of the office, vacation notices, work schedules/assignments, after-hours messages, birthdays, and sales force motivational messages. As in the children's version, the unit can include blank stickers that the user may use to create his own categories of information and reminders.

In a palm-sized adult version, the unit's display could be an LCD touch sensitive screen mounted in front of the unit. A stylus can be provided for input use, with a stylus holder incorporated into the unit's body design. The palm-sized unit would be approximately 3 inches (about 7.6 cm) wide by 5 inches (about 13 cm) high by about 0.5 inches (about 1.3 cm) thick.

It will be appreciated that the term “present invention” as used herein should not be construed to mean that only a single invention having a single essential element or group of elements is presented. Similarly, it will also be appreciated that the term “present invention” encompasses a number of separate innovations which can each be considered separate inventions. Although the present invention has thus been described in detail with regard to the preferred embodiments and drawings thereof, it should be apparent to those skilled in the art that various adaptations and modifications of the present invention may be accomplished without departing from the spirit and the scope of the invention. Accordingly, it is to be understood that the detailed description and the accompanying drawings as set forth hereinabove are not intended to limit the breadth of the present invention, which should be inferred only from the following claims and their appropriately construed legal equivalents.

1. A talking calendar comprising:
a visual display of days of year within a current year;
a memory containing pre-recorded audio information pertaining to historical events from prior years;
at least one sensor for detecting when a user selects a first day of year from said displayed days of year;
an audio speaker;
a controller for selecting date-specific historical information from said memory according to the selected day of year and sending said date-specific historical information to said speaker for playing, such that the user hears an educational message pertaining to a historical event which occurred on the selected day of year in a prior year.

2. The talking calendar of claim 1 wherein the visual display comprises a printed calendar sheet.

3. The talking calendar of claim 1 wherein the talking calendar is palm-sized.

4. The talking calendar of claim 2 wherein the at least one sensor comprises a plurality of switches disposed underneath the printed calendar sheet for sensing when a user has pressed a day on the calendar sheet.

5. The talking calendar of claim 2 wherein the printed sheet pertains to a particular month of year, the printed sheet includes a machine-readable code identifying said particular month of year, and wherein the talking calendar further includes a reader operatively connected to the controller for reading the machine-readable code and communicating information coded therein to the controller.

6. The talking calendar of claim 1 further comprising:
a microphone for recording a user-recorded message, and wherein the controller associates the recorded message with a second day of year selected by the user for later playback.

7. The talking calendar of claim 6 wherein the printed calendar sheet is a writable calendar sheet, such that a single calendar device allows a user to record a combination of written information and recorded oral information relating to a particular date for later review.

8. The talking calendar of claim 6 wherein the user can select a third day of year and retrieve a user-recorded message associated with said third day of year from a prior year for playback.

9. The talking calendar of claim 1 wherein said talking calendar is an educational toy for children.

10. The talking calendar of claim 5 further comprising:
additional printed sheets, the printed sheets together defining monthly calendar sheets for each of the twelve months within a year, and wherein each of the monthly calendar sheets has a machine-readable month code.

11. The talking calendar of claim 10 wherein each monthly calendar sheet further includes a machine-readable year code.

12. The talking calendar of claim 6 further comprising:
a plurality of category switches whereby the user can record user-recorded information according to a selected one of a plurality of categories and later play back user-recorded information according to the selected category.

13. The talking calendar of claim 6 further comprising:
a plurality of modular removable writable memories, each modular memory corresponding to a respective year.

14. The talking calendar of claim 4 wherein the calendar sheet comprises a first calendar sheet, the talking calendar further comprising:
eleven additional calendar sheets, the calendar sheets together defining twelve monthly calendar sheets, one calendar sheet for each month of the year; and
a housing having a first slot and a second slot:
the first slot for receiving the first calendar sheet and holding the calendar sheet in proximity to the switches such that a user pressing on a day of the calendar sheet will cause a corresponding switch to be activated thereby indicating the user's day of year selection to the controller; and
the second slot for receiving and holding the eleven additional calendar sheets.

15. The talking calendar of claim 1 wherein the visual display of days of year within the current year comprises an electronic display.

16. The talking calendar of claim 1 wherein the talking calendar further comprises means for hanging said calendar on a wall.

17. The talking calendar of claim 1 further comprising:
a computer interface for receiving date-specific data for later playback through said audio speaker upon selection of a corresponding date by said user.

18. The talking calendar of claim 17 wherein said date-specific data is programmed into a writable memory, the date-specific data having been chosen at least in part on the basis of the user's age and at least one of the user's ethnicity and religion.

19. A talking calendar comprising:
a plurality of monthly sheets, each sheet having a machine-readable code corresponding to a respective month of the year; and
a housing for receiving a selected one of the monthly sheets, said housing comprising;
a housing body;
at least one reader for reading said machine readable code in order to associate said selected monthly sheet with the sheet's respective month;
a user input section whereby a user can select a day of said month by touching a portion of said selected sheet corresponding to said selected day;
a memory containing information pertaining to each of a plurality of respective days; and
a playback section for producing an audible playback of said information according to said user's day selection.

20. The talking calendar of claim 19 wherein the information includes information regarding events in history.

21. The talking calendar of claim 19 wherein the information includes information regarding holidays.

22. The talking calendar of claim 19 wherein the housing further comprises:
a recording section for recording for later playback oral information associated with the user-selected day.

23. The talking calendar of claim 19 wherein the information includes information in each of a plurality of separate categories, with the user recording and playing back the information according to both the user's day selection and a category selection by the user.

24. The talking calendar of claim 23 further comprising:
a plurality of buttons on the housing; and
a sheet of adhesive labels, the labels containing indicia therein to indicate different respective categories of information, the labels being suitable for selective removal from said sheet and affixing in correspondence with respective ones said buttons, whereby the user can ascribe selected predefined categories of information to said buttons.

25. The talking calendar of claim 19 wherein said memory comprises both read-only memory and writable memory, the read-only memory containing information regarding historical events, and the writable memory containing user-programmed information regarding recent events.

26. The talking calendar of claim 25 wherein said memory comprises both read-only memory and writable memory:
the read-only memory containing pre-recorded educational information accessed via a first at least one button; and
the writable memory containing information recordable by the user and accessed via a second at least one button.

27. The talking calendar of claim 26 wherein:
the button which accesses the pre-recorded information is a fixed function button pre-marked with indicia characterizing the pre-recorded information accessed thereby; and
the button which accesses the recordable information is a user-defined button.

28. The talking calendar of claim 19 in combination with machine readable code capable of causing a computer and printer to print one of said monthly sheets having said machine-readable code thereon.

29. A talking calendar comprising:
a housing including a microphone, a speaker, and a control unit, the control unit receiving input data via the microphone and outputting audible messages via the speaker;
at least one fixed function switch for accessing preprogrammed information pertaining to selected dates according to subject matter of said information; and
a plurality of inputs for defining separate categories of voice messages to be separately recorded and retrieved.
